(19) United States
(12) Patent Application Publication
(10) Pub. No.: US 2019/0286989 A1
(43) Pub. Date: Sep. 19, 2019

(54) DISTRIBUTED NEURAL NETWORK MODEL UTILIZATION SYSTEM

(71) Applicant: Polarr, Inc., Palo Alto, CA (US)

(72) Inventors: Borui Wang, China (CN); Derek Yan, Canada (CA)

(21) Appl. No.: 15/922,686

(22) Filed: Mar. 15, 2018

(51) Int. Cl. G06N 3/08; G06T 11/60; G06F 8/20; H04L 29/08

(52) U.S. Cl. CPC G06N 3/082; H04L 67/04; G06F 8/20; G06T 11/60

(57) ABSTRACT

A system includes an image labeler to receive one or more images and associate one or more labels with each of the one or more images, a neural network generator to build a neural network from the one or more images and the one or more labels, a neural network compressor to compress the neural network into a compressed neural network, and a software development kit on a client device to receive and embed the compressed neural network, receive an input from the client device, interface with the compressed neural network to generate a result from the input and send the result to the client device to be displayed on a machine display of the client device.

### BACKGROUND

Neural networks are both computationally intensive and memory intensive, making them difficult to deploy on embedded systems with limited hardware resources, such as mobile devices, tablets, personal computers, etc. Although having neural networks running on the devices has many great features such as better privacy, less network bandwidth, and real time processing, the large storage overhead inhibits these neural networks from being incorporated into those devices.

Also, operating large neural networks utilizes a large amount of memory bandwidth to fetch the weights and a lot of computation to perform dot products—which in turn consumes considerable energy. The devices may be battery constrained and therefor power-intensive applications such as neural networks may be difficult to deploy.

A need therefore exists to reduce the storage requirement of neural networks while still maintaining their accuracy, to facilitate the use of neural networks in devices where size and download bandwidth may be constrained.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a sequence diagram 100.

FIG. 2 illustrates an embodiment of a system 200.

FIG. 3 illustrates an embodiment of a system 300.

FIG. 4 illustrates an embodiment of a method 400.

FIG. 5 is an example block diagram of a computing device 500 that may incorporate embodiments of the present invention.

### DETAILED DESCRIPTION

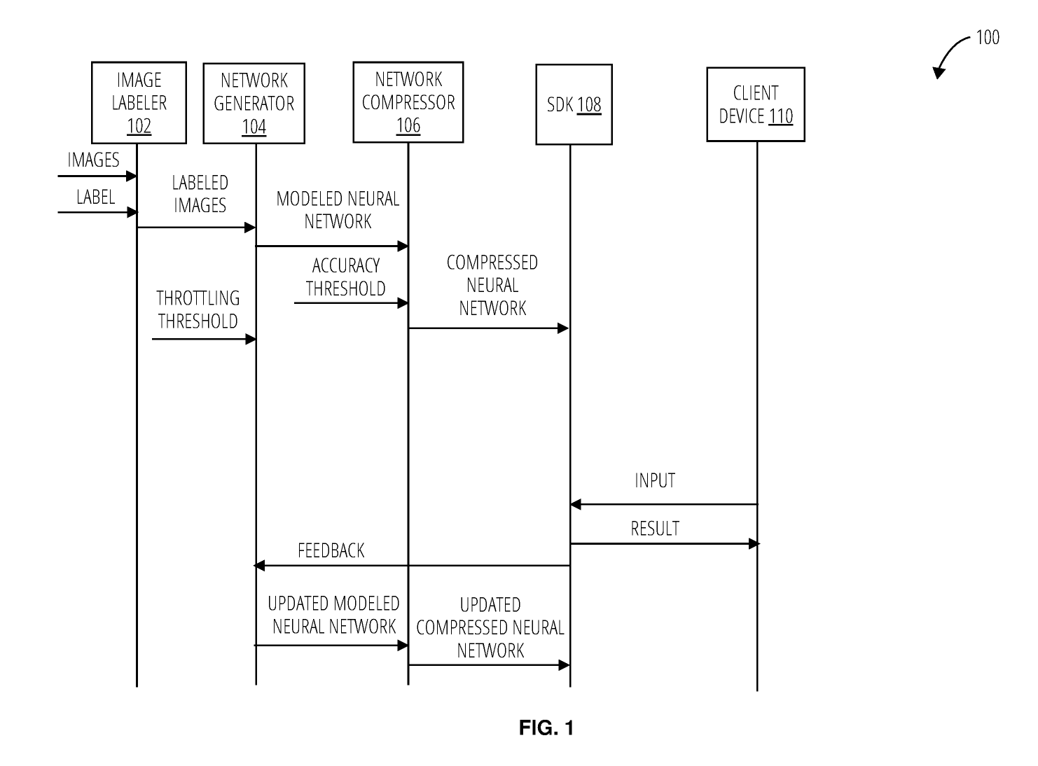

Referring to FIG. 1, a sequence diagram 100 comprises an image labeler 102, a network generator 104, a network compressor 106, a software development kit 108, and a client device 110.

The image labeler 102 receives one or more images. The image labeler 102 then receives one or more labels to associate with each of the one or more images. The image labeler 102 then sends the labeled images to the network generator 104.

The network generator 104 receives the labeled images from the image labeler 102. The network generator 104 builds a neural network utilizing the labeled images. The network generator 104 then sends the modeled neural network to the network compressor 106. The network generator 104 may also receive a throttling threshold. The throttling threshold may be utilized with the feedback to update the neural network based on the operation of the neural network.

The network compressor 106 receives the modeled neural network from the network compressor 106. The network compressor 106 also receives an accuracy threshold. The network compressor 106 then compresses the modeled neural network into a compressed neural network utilizing compression techniques, such as pruning and altering bit accuracy. The network compressor 106 may utilize an iterative process of compressing the neural network and comparing the compressed neural network to the accuracy threshold to achieve a compressed neural network that maintains the specified accuracy threshold. The network compressor 106 then sends the compressed neural network to the software development kit 108.

A client device 110 then sends an input to the software development kit 108. The input may be an image. The software development kit 108 utilizes the interface with the embedded compressed neural network to determine a result, which is sent to the client device 110 to be displayed. The software development kit 108 may, in some embodiments, send the result as feedback to the network generator 104. The result may be a rating of the image. For example, the overall rating value may be from 1.0 to 5.0 (where 1.0 is the worst and 5.0 is the best), which is based on further metrics. The metrics, which may also be rated, include colorfulness, exposure (i.e., a well-exposed photo or poorly exposed, including under-exposed or over-exposed), clarity (i.e., the blurriness of the photo), expression (e.g., if faces are detected, are they smiling, are the eyes open), etc. The result may also be a grouping of the image with similar images based on subjects, features, colors, and other metrics. The result may also be objects associated with the image. In one embodiment, the result is the top three objects from the image. The input may also be a string, such as the name of an object, the result being images associated with the object. The images may be stored on the client device.

The network generator 104 may utilize the feedback, the labeled images, additional labeled images, etc., or some combination thereof, to update the modeled neural network. In some embodiments, the network generator 104 receives and utilizes an update threshold to determine whether to send the updated neural network to the network compressor 106. The network generator 104 may measure the difference between the initial neural network and the updated neural network and sends the updated neural network when it exceeds the initial neural network by the update threshold. The network generator 104 may also utilize the throttling threshold to determine whether the performance of the neural network on the client device 110 is acceptable, as well as to determine whether to update the neural network. The updated neural network is then sent to the network compressor 106 to be compressed into an updated compressed neural network. The network compressor 106 sends the updated compressed neural network to the software development kit 108.

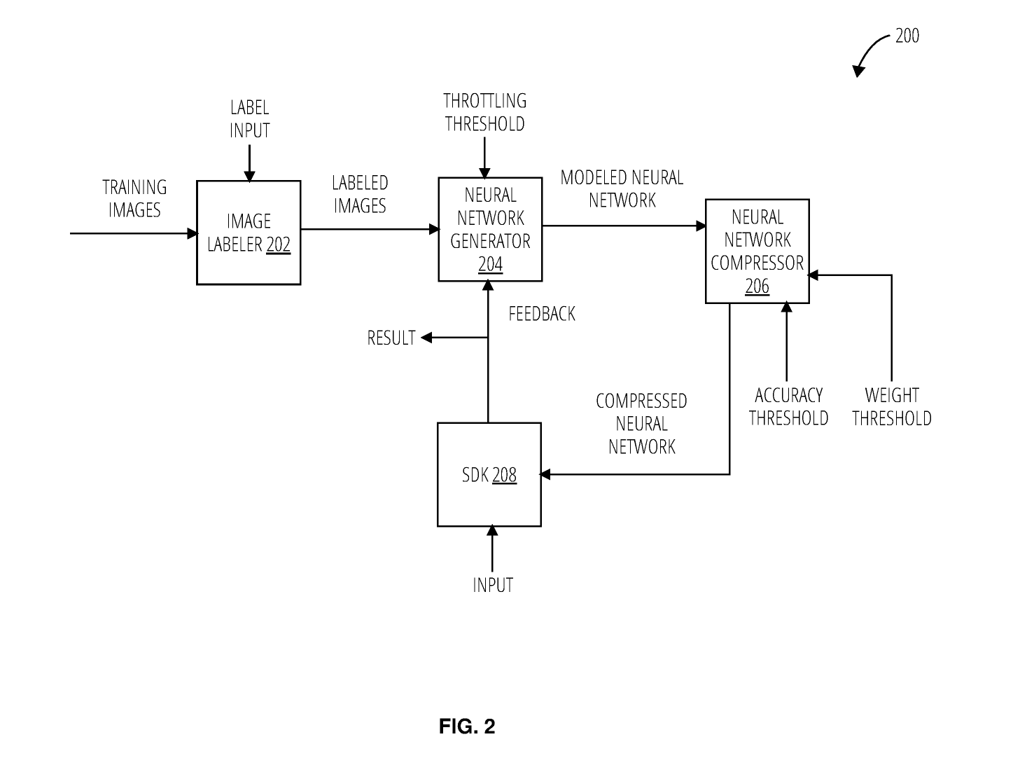

Referring to FIG. 2, the system 200 comprises an image labeler 202, a neural network generator 204, a neural network compressor 206, and a software development kit 208.

The image labeler 202 receives training images and label input for each of the training images. The image labeler 202 associates the training images with the label inputs. The labels may include rating on a scale, such as 1-10. The ratings may be an overall rating or a rating for a metric, such as clarity, detail, exposure, color, etc. The labels may also include an indication of facial expression or the presence of an object. In some embodiments, this process is performed with manual inputs with the image labeler 202 as a computer-aided device to perform the image labeling. The image labeler 202 sends the labeled images to the neural network generator 204. The image labeler 202 may continue to send labeled images to the neural network generator 204 after the neural network generator 204 has generated a modeled neural network, which may be utilized as further training images.

The neural network generator 204 receives the labeled images from the image labeler 202, the result as feedback from the software development kit 208, and a throttling threshold. The feedback result may be received in embodiments in which the software development kit 208 is configured to send the feedback result. The throttling threshold may be utilized with the feedback to determine whether the performance of the neural network on an embedded device is acceptable, including whether to update the neural network to increase the performance of the neural network. The feedback and the throttling threshold may be a measure of the computation per second at the interface of the software development kit 208 and the embedded compressed neural network or a measure of the system resources utilized by the software development kit 208 and the embedded compressed neural network during operation, as well as the accuracy of the result. The neural network generator 204 may be part of a network, such as cloud network or server network. The neural network generator 204 utilizes the initial set of labeled images to generate the initial modeled neural network. The neural network generator 204 may also include a neural network updating system. The neural network updating system may utilize the additional labeled images and/or the feedback results to alter the initial modeled neural network. The neural network updating system may include an update threshold that is utilized to determine whether the updated neural network is to be sent to the neural network compressor 206. The update threshold may be a measure of the difference in the output of each modeled neural network. The neural network generator 204 sends the modeled neural network or the modeled updated neural network to the neural network compressor 206.

The neural network compressor 206 receives the modeled neural network or the updated neural network, a weight threshold for pruning, and an accuracy threshold for the bit accuracy. The neural network compressor 206 then compresses the neural network utilizing pruning and quantization. In one embodiment, pruning employs a three-step process. First, connectivity is learned via network training. The network training provides a measure in weights of the important connections. This step may be performed without determining the final values of the weights. The second step is to remove the low-weight connections. For example, the connections with weights below the weight threshold are removed from the network, which converts the dense network into a sparse network. The final step retrains the network to learn the final weights for the remaining sparse connections. Further, pruning may be iterated. The resulting sparse network may have removed connections (synapses) between nodes (neurons) and may further remove nodes (neurons) with no remaining connections (synapses). In one embodiment, quantization is utilized to alter the bit accuracy while reducing the bits utilized for the weights of the neural network. A k-means clustering technique is utilized to identify the shared weights for each layer of a neural network, such that all the weights that fall into the same cluster will share the same weight. In some embodiments, weights are not shared across layers. The clusters may be determined by minimizing the within-cluster sum of squares. The shared weights (also, centroids) are then initialized. Linear initialization linearly spaces the centroids between the [min, max] of the original weights. In other embodiments, random (Forgy) or density-based initialization may be utilized. The gradient for each of the shared weights is then determined and utilized to alter the centroid. The gradient for each centroid may be determined by first determining the gradient for each weight, then summing the gradients for each cluster. Quantization and weight sharing may be implemented by maintaining a codebook structure that stores the shared weight, and group-by-index after calculating the gradient of each layer. Each shared weight is updated with all the gradients that fall into that bucket. The finalized shared weights may be compared to the original weights and compared to the accuracy threshold. For example, a loss relating the shared weights to the original weights may be determined and compared to the accuracy threshold to determine whether to re-determine the shared weight, such as by increasing the number of clusters. An accuracy threshold may be for each individual weight, for all or some number of the weights, or some combination thereof. In some embodiments, Huffman coding may be performed to further compress the neural network. The neural network compressor 206 then sends the compressed neural network to the software development kit 208.

The software development kit 208 receives the compressed neural network and inputs. The compressed neural network is embedded (installed such that there's an intervening operational interface) into the software development kit 208. The software development kit 208 then interfaces with the compressed neural network, for example via a throttling interface. In response to the input, the software development kit 208 may access the embedded compressed neural network via the interface to return a result. The input may be an image. The input may also be a string, such as the name of an object, the result being images associated with the object. The images may be stored on the client device. The result may be a rating of the image. For example, the overall rating value may be from 1.0 to 5.0 (where 1.0 is the worst and 5.0 is the best), which is based on further metrics. The metrics, which may also be rated, include colorfulness, exposure (i.e., a well-exposed photo or poorly exposed, including under-exposed or over-exposed), clarity (i.e., the blurriness of the photo), expression (e.g., if faces are detected, are they smiling, are the eyes open), etc. The result may also be a grouping of the image with similar images based on subjects, features, colors, and other metrics. The result may also be objects associated with the image. In one embodiment, the result is the top three objects from the image. Exemplary operation to covert an input to a result is provided in Listing (i). The result may be sent to the neural network generator 204 as feedback to update the neural network.

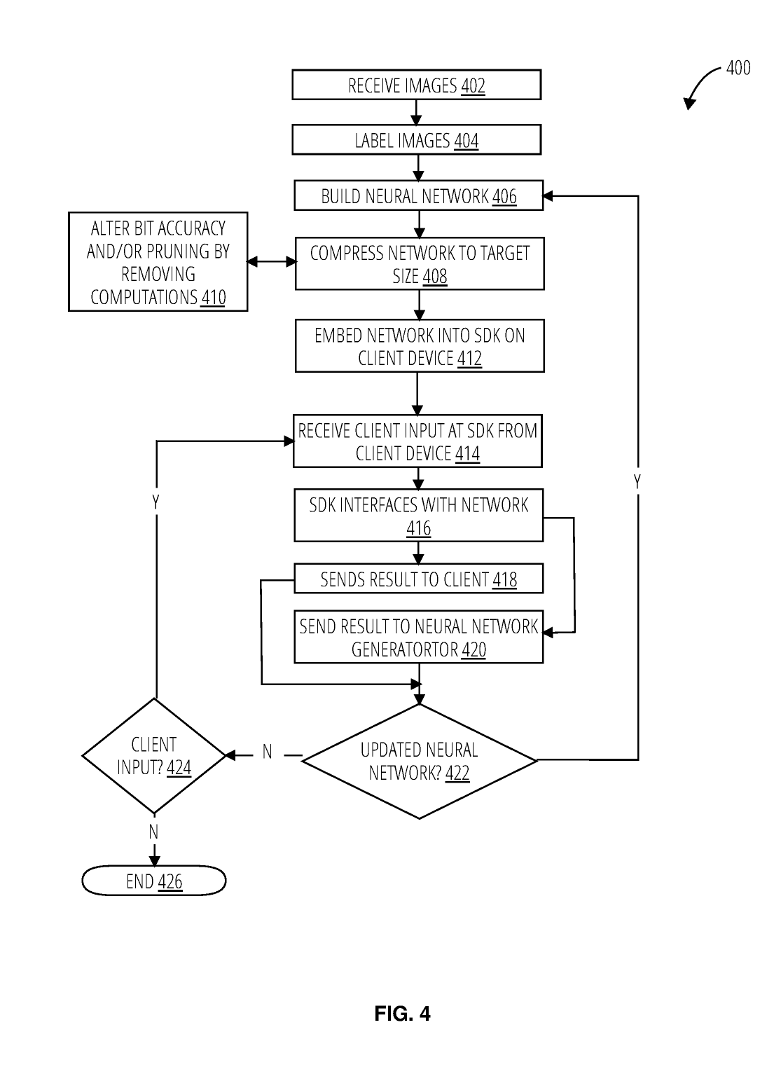

The system 200 may be operate according to the process depicted in FIG. 4.

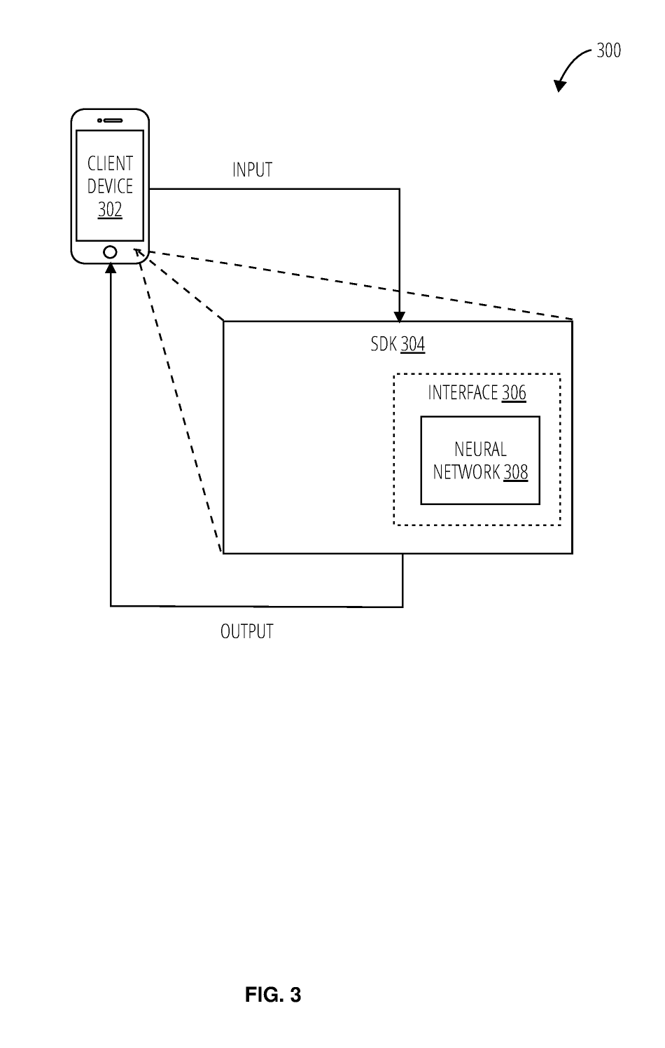

Referring to FIG. 3, the system 300 comprises a client device 302, a software development kit 304, an interface 306, and a neural network 308.

The client device 302 may be a desktop computer, rackmount computer, in-car computer, game console, laptop or notebook computer, tablet computer, Smartphone, smartbook, personal digital assistant or palmtop computer, programmable calculator, or handheld game console, or any embedded device, including those in vehicles, drones, automated machines, etc. The client device 302 may store and execute the software development kit 304 when instructed. The client device 302 may be instructed to operate the software development kit 304 by a user input to an input device of the client device 302, such as a haptic input, audio input, operation of a component of the client device 302, including a camera, etc. The client device 302 sends an input to the software development kit 304 and receives an output (or result) from the software development kit 304. The result may alter the client device 302 to display the result on a machine display of the client device 302, such as a list of features related to an image. The result or output may also be alter files (such as image file) or a file system to associate the image with other images on the client device 302, and/or add a rating may to the image file that may displayed when the image is display, and/or alter the order that images are displayed on the client device 302 (for example, by rating, etc.).

The software development kit 304 receives an input from the client device 302 and sends an output in response. The software development kit 304 utilizes the interface 306 to access the neural network 308. The software development kit 304 may have various functions to utilize the neural network 308. Exemplary processes for accessing the neural network 308 are depicted in Listing (i).

The interface 306 is a throttled connection by which the software development kit 304 interfaces with the neural network 308. The interface 306 may be altered to increase or decrease the system resources utilized by the client device 302 while the software development kit 304 accesses the neural network 308. The interface 306 may also limit the number of computations by the neural network 308 to produce the output, according to a throttling threshold configured within the interface 306 or the associated software development kit 304.

The neural network 308 is embedded within the software development kit 304. The neural network 308 is accessed by the software development kit 304 via the interface 306. The neural network 308 may be a compressed neural network to enhance the ability to operate on a client device 302. The neural network 308 is trained with labeled images to determine ratings and features of an input.

The system 300 may be operated according to the process depicted in FIG. 4.

Referring to FIG. 4, a method 400 receives one or more images (block 402). Each of the one or more images are labeled with one or more labels (block 404). In some embodiments, the labels are added manually. The labeled images are utilized to build a neural network (block 406). The neural network is compressed to a target size (block 408). The compression step may alter the bit accuracy, such as by quantization, and may remove computations by pruning (block 410). In some embodiments, pruning is performed prior to quantization, and/or both steps are tuned to a threshold execution load for the neural network corresponding to a target device to host the neural network. These steps may be performed iteratively. Additionally, Huffman coding may be performed to further compress the neural network. The compressed neural network is then embedded into a software development kit on a client device (block 412).

A client input is received at the software development kit from the client device (block 414). The software development kit interfaces the embedded compressed neural network to determine a result (block 416). The result is sent to the client device (block 418). The client device may be altered to display the result or to alter files associated with the input, such as an image. The result is then sent as feedback to a neural network generator (block 420). In some embodiments, the result is not sent based on the configuration of the client device.

The method 400 then determines whether there is an update to the neural network (decision block 422). If so, additional labeled images and/or the feedback results may be utilized with an update threshold to determine generate an updated neural network (block 406), which is then compressed (block 408). The updated neural network is embedded onto the client device (block 412). If there is not an update, the method 400 determines whether there is another client input (decision block 424). If so, the software development kit receives the client input (block 414). If not, the method 400 ends (done block 426).

Thus, in one mode of operation, one or more client devices receive a compressed neural network from a wireless data network and embed the compressed neural network in a software development kit. The compressed neural network is compressed (e.g., quantized) specifically to account for the capabilities (e.g., memory, processor speed) of the client device. The compressed neural network is embedded with a throttling interface interposed between the neural network and a processor of the client device. A digital image is input to the software development kit, and the compressed neural network is operated on the digital image via the throttling interface to generate a grouping of digital images formed based on a common type of object depicted in the image (e.g., a face, animal, a person, or other object). Each of the digital images in the grouping may include a rating, and the images are displayed on the client device display, possibly in a ranked order, based on the rating (e.g., highest ranked image based on detected object type is ranked highest in order or position). The software development kit receives user input adjusting the rating or ranked order, and stores results of the user input (changed rankings, rejected images, for example) in association with the digital images and common object type, for upload to a server system via a data network, which may be wireless.

A centralized server system generates an uncompressed neural network and trains the uncompressed neural network based on a training set. This server system receives the results of the user input from the first device, and similarly generated stored results from a plurality of other devices, via the wireless data network. The server system retrains the uncompressed neural network with the results of the user input, and compresses the uncompressed neural network into a compressed neural network by applying quantization based on execution capabilities of the first device. The compressed neural network is then transmitted to the first device and to a set of other devices that are a same type as the first device.

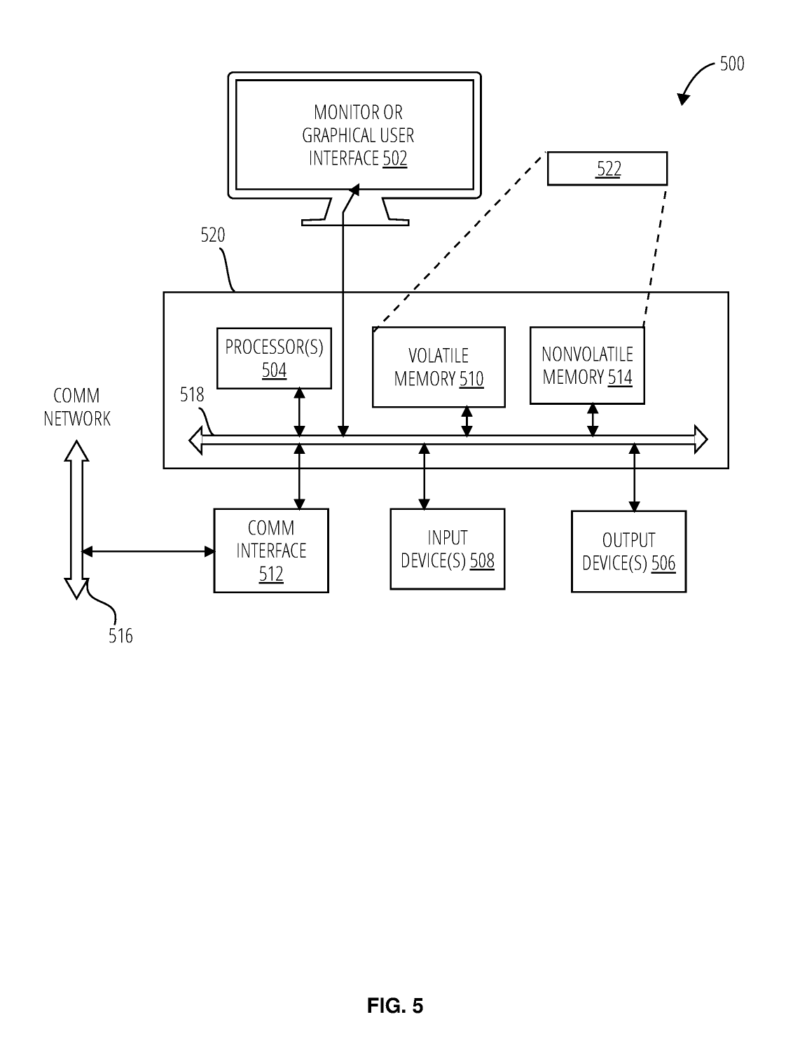

FIG. 5 is an example block diagram of a computing device 500 that may incorporate embodiments of the present invention. FIG. 5 is merely illustrative of a machine system to carry out aspects of the technical processes described herein, and does not limit the scope of the claims. One of ordinary skill in the art would recognize other variations, modifications, and alternatives. In one embodiment, the computing device 500 typically includes a monitor or graphical user interface 502, a data processing system 520, a communication network interface 512, input device(s) 508, output device(s) 506, and the like.

As depicted in FIG. 5, the data processing system 520 may include one or more processor(s) 504 that communicate with a number of peripheral devices via a bus subsystem 518. These peripheral devices may include input device(s) 508, output device(s) 506, communication network interface 512, and a storage subsystem, such as a volatile memory 510 and a nonvolatile memory 514.

The volatile memory 510 and/or the nonvolatile memory 514 may store computer-executable instructions and thus forming logic 522 that when applied to and executed by the processor(s) 504 implement embodiments of the processes disclosed herein.

The input device(s) 508 include devices and mechanisms for inputting information to the data processing system 520. These may include a keyboard, a keypad, a touch screen incorporated into the monitor or graphical user interface 502, audio input devices such as voice recognition systems, microphones, and other types of input devices. In various embodiments, the input device(s) 508 may be embodied as a computer mouse, a trackball, a track pad, a joystick, wireless remote, drawing tablet, voice command system, eye tracking system, camera, webcam, and the like. The input device(s) 508 typically allow a user to select objects, icons, control areas, text and the like that appear on the monitor or graphical user interface 502 via a command such as a click of a button or the like.

The output device(s) 506 include devices and mechanisms for outputting information from the data processing system 520. These may include the monitor or graphical user interface 502, speakers, printers, infrared LEDs, and so on as well understood in the art.

The communication network interface 512 provides an interface to communication networks (e.g., communication network 516) and devices external to the data processing system 520. The communication network interface 512 may serve as an interface for receiving data from and transmitting data to other systems. Embodiments of the communication network interface 512 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 512 may be coupled to the communication network 516 via an antenna, a cable, or the like. In some embodiments, the communication network interface 512 may be physically integrated on a circuit board of the data processing system 520, or in some cases may be implemented in software or firmware, such as “soft modems”, or the like.

The computing device 500 may include logic that enables communications over a network using protocols such as HTTP, TCP/IP, RTP/RTSP, IPX, UDP, HTTPS, FTP, and the like.

The volatile memory 510 and the nonvolatile memory 514 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 510 and the nonvolatile memory 514 may be configured to store the basic programming and data constructs that provide the functionality of the disclosed processes and other embodiments thereof that fall within the scope of the present invention.

Logic 522 that implements embodiments of the present invention may be stored in the volatile memory 510 and/or the nonvolatile memory 514. Said logic 522 may be read from the volatile memory 510 and/or nonvolatile memory 514 and executed by the processor(s) 504. The volatile memory 510 and the nonvolatile memory 514 may also provide a repository for storing data used by the logic 522.

The volatile memory 510 and the nonvolatile memory 514 may include a number of memories including a main random access memory (RAM) for storage of instructions and data during program execution and a read only memory (ROM) in which read-only non-transitory instructions are stored. The volatile memory 510 and the nonvolatile memory 514 may include a file storage subsystem providing persistent (non-volatile) storage for program and data files. The volatile memory 510 and the nonvolatile memory 514 may include removable storage systems, such as removable flash memory.

The bus subsystem 518 provides a mechanism for enabling the various components and subsystems of data processing system 520 communicate with each other as intended. Although the communication network interface 512 is depicted schematically as a single bus, some embodiments of the bus subsystem 518 may utilize multiple distinct busses.

It will be readily apparent to one of ordinary skill in the art that the computing device 500 may be a device such as a smartphone, a desktop computer, a laptop computer, a rack-mounted computer system, a computer server, or a tablet computer device. As commonly known in the art, the computing device 500 may be implemented as a collection of multiple networked computing devices. Further, the computing device 500 will typically include operating system logic (not illustrated) the types and nature of which are well known in the art.

### Interpretation and Terminology

Terms used herein should be accorded their ordinary meaning in the relevant arts, or the meaning indicated by their use in context, but if an express definition is provided, that meaning controls.

“Bit accuracy” herein refers to a measure of the difference between a calculated weight and the weight utilized in a compressed neural network.

“Classifier” herein refers to a specific type of correlator/associator logic that associates one or more inputs with a category, class, or other group sharing one or more common characteristics. An example of a classifier that may commonly be implemented in programmable hardware is a packet classifier used in network switches, firewalls, and routers (e.g., packet classifiers utilizing Ternary Content Addressable Memories). An example software or firmware classifier is: if (input1.value<12.5) input1.group=group1; else if (input1.value>=12.5 and input1.value<98.1) input1.group=group2; else input1.group=group3; Other examples of classifiers will be readily apparent to those of skill in the art, without undo experimentation.

“Clock” herein refers to a circuit that generates a periodic signal, with a rate typically measured in cycles per second (measured in hertz, kilohertz, megahertz or gigahertz), to drive the operation of a synchronous circuit. A typical digital clock cycle toggles between a logical zero and a logical one state.

“Combiner” herein refers to a logic element that combines two or more inputs into fewer (often a single) output. Example hardware combiners are arithmetic units (adders, multipliers, etc.), time-division multiplexers, and analog or digital modulators (these may also be implemented is software or firmware). Another type of combiner builds an association table or structure (e.g., a data structure instance having members set to the input values) in memory for its inputs. For example: val1, val2, val3->combiner logic->{val1, val2, val3} set.val1=val1; set.val2=val2; set.val3=val3; Other examples of combiners will be evident to those of skill in the art without undo experimentation.

“Comparator” herein refers to a logic element that compares two or more inputs to produce one or more outputs that reflects similarity or difference of the inputs. An example of a hardware comparator is an operational amplifier that outputs a signal indicating whether one input is greater, less than, or about equal to the other. An example software or firmware comparator is: if (input1==input2) output=val1; else if (input1>input2) output=val2; else output=val3; Many other examples of comparators will be evident to those of skill in the art, without undo experimentation.

“Compressed neural network” herein refers to a neural network with nodes or connections removed or estimated to reduce the number of bits associated with the neural network.

“Computations” herein refers to a connection or node in a neural network.

“Correlator” herein refers to a logic element that identifies a configured association between its inputs. One examples of a correlator is a lookup table (LUT) configured in software or firmware. Correlators may be implemented as relational databases. An example LUT correlator is: |low_alarm_condition |low_threshold_value| 0 | |safe_condition |safe_lower_bound |safe_upper_bound| |high_alarm_condition|high_threshold_value| 0 | Generally, a correlator receives two or more inputs and produces an output indicative of a mutual relationship or connection between the inputs. Examples of correlators that do not use LUTs include any of a broad class of statistical correlators that identify dependence between input variables, often the extent to which two input variables have a linear relationship with each other. One commonly used statistical correlator is one that computes Pearson's product-moment coefficient for two input variables (e.g., two digital or analog input signals). Other well-known correlators compute a distance correlation, Spearman's rank correlation, a randomized dependence correlation, and Kendall's rank correlation. Many other examples of correlators will be evident to those of skill in the art, without undo experimentation.

“Embedded device” herein refers to a computer system with a dedicated function within a larger mechanical or electrical system. It is embedded as part of a complete device often including hardware and mechanical parts.

“Neural network” herein refers to a computing system similar to biological neural networks having a collection of connected units or nodes called artificial neurons (a simplified version of biological neurons in an animal brain), each connection (a simplified version of a synapse) between artificial neurons can transmitting a signal from one to another with a weight to the connection.

“Labels” herein refers to target final outputs for a given input.

“Parser” herein refers to logic that divides an amalgamated input sequence or structure into multiple individual elements. Example hardware parsers are packet header parsers in network routers and switches. An example software or firmware parser is: aFields=split(“val1, val2, val3”, “,”); Another example of a software or firmware parser is: readFromSensor gpsCoordinate; x_pos=gpsCoordinate.x; y_pos=gpsCoordinate.y; z_pos=gpsCoordinate.z; Other examples of parsers will be readily apparent to those of skill in the art, without undo experimentation.

“Quantization” herein refers to a method of estimating weights of a neural network utilizing clustering of nodes and weight sharing.

“Sequencer” herein refers to logic to generate an ordered list of outputs from either an unordered or partially ordered set of inputs, or from a starting input and rules to generate next inputs. One attribute of a sequencer is that the outputs are done sequentially, meaning one after the other in time. An example of a hardware sequencer is a multiplexer with a counter driving its selection input. An example of a software or firmware sequencer is: out=val++; Other examples of hardware and software or firmware sequencers will now be readily apparent to those of skill in the relevant arts.

“Software development kit” herein refers to a set of software development tools that allows the creation of applications for a certain software package, software framework, hardware platform, computer system, video game console, operating system, or similar development platform.

“Throttling threshold” herein refers to a pre-determined magnitude of the measure of system resources utilized by a software development kit interfacing with an embedded neural network.

“Update threshold” herein refers to a pre-determined magnitude of the difference in accuracy of a two neural networks acting upon a test dataset to result in the more accurate neural network replacing the less accurate neural network.

“Circuitry” herein refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” herein refers to software logic embodied as processor-executable instructions stored in read-only memories or media.

“Hardware” herein refers to logic embodied as analog or digital circuitry.

“Logic” herein refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” herein refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

COMPUTER CODE LISTING

```
        //Rating photo
        //Rating a photo file. The score from 1.0 to 5.0.
        //Rating by file path
        String filePath;
        boolean isBurst = false;
        Map<String, Object> result =
Processing.processingFile(context, filePath, isBurst);
        //Rating by bitmap
        //Need a fit scaled bimap. The max width or height less
then 300px. It will resize to 300px if exceeded.
        Bitmap bitmap;
        long fileCreateTime; // millisecond.
        boolean isBurst = false;
        Map<String, Object> featureResult =
Processing.processingFile(context, bitmap, fileCreateTime,
isBurst);
        //Rating results
        float metric_clarity =
(float)result.get(“metric_clarity”);
        float metric_exposure =
(float)result.get(“metric_exposure”);
        float metric_colorfulness =
(float)result.get(“metric_colorfulness”);
        float metric_emotion =
(float)result.get(“metric_emotion”);
          float rating_all = (float)result.get(“rating_all”);
        //Tagging photo
        //Recognize a photo, get top 3 possible objects from
the photo
        // scale photo to 224×224
        Bitmap bitmap =
ImageUtil.getScaledBitmap(photo.getPath( ), 224, 224);
        Map<String, Object> taggingResult =
TaggingUtil.tagPhoto(context.getAssets( ), bitmap);
        // marge the result with processing result
        result.putAll(taggingResult);
        //Grouping photos
        //First, rating and tagging photo to a feature result.
Then grouping the feature results.
        //Feature a photo
        //Join rating result and tagging result.
        String filePath;
        boolean isBurst = false;
        Map<String, Object> featureResult =
Processing.processingFile(context, filePath. isBurst);
        Bitmap bitmap = ImageUtil.getScaledBitmap(filePath,
224, 224);
        Map<String, Object> taggingResult =
TaggingUtil.tagPhoto(getAssets( ), bitmap);
        featureResult.putAll(taggingResult);
        //Grouping feature results
        init photo files
        List<File> realPhotos = new ArrayList<>( );
        //Get features of photos
        List<Map<String, Object>> features = new ArrayList<>( );
        boolean isBurst = false;
        for (File photo : realPhotos) {
            Map<String, Object> featureResult =
Processing.processingFile(context, photo.getPath( ). isBurst);
            Bitmap bitmap =
ImageUtil.getScaledBitmap(photo.getPath( ), 224, 224);
            Map<String, Object> taggingResult =
TaggingUtil.tagPhoto(getAssets( ), bitmap);
            featureResult.putAll(taggingResult);
            features.add(featureResult);
        }
        //Grouping photos
        String identifier = “group1”;
        List<Map<String, Object>> features = new ArrayList<>( );
        boolean isBurst = false;
        float sensitivity = 1f; //(0.1,1)
        GroupingResultItem result =
Processing.processingGrouping(identifier, features, isBurst,
sensitivity, new POGenerateHClusterCallbackFunction( ) {
            @Override
            public void progress (double progress) {
                // grouping progress
            }
        });
        //Convert results
        Map<Integer, List<List<Integer>>> groups =
result.groups;
        int opt = result.optimalGroupIndex;
        List<List<Integer>> optGroups = groups.get(opt);
        List<List<ResultItem>> groupdFiles = new ArrayList<>( );
        for (List<Integer> subGroup : optGroups) {
          List<ResultItem> sub = new ArrayList<>( );
          for (Integer index : subGroup) {
              ResultItem resultItem = new ResultItem( );
              resultItem.filePath =
realPhotos.get(index).getPath( );
              resultItem.features = features.get(index);
              sub.add(resultItem);
          }
          groupdFiles.add(sub);
        }
        //Get the best one
        ResultItem bestItem = Processing.getBest(groupdFiles);
        //Order photos
        Processing.sortGroupsByScore(groupdFiles);
        //Order the photos with face detection
        List<Map<String, Object>> features = new ArrayList<>( );
        GroupingResultItem result =
Processing.processingFaces(features);
```

What is claimed is:

1. A system comprising a first non-transitory machine memory comprising first instructions that, when executed by a first machine processor, operate a first device comprising the first processor to:
receive a compressed neural network from a wireless data network and embed the compressed neural network in a software development kit;
the compressed neural network embedded with a throttling interface interposed between the neural network and the processor;
receive a digital image input to the software development kit;
operate the compressed neural network on the digital image via the throttling interface to generate a grouping of digital images formed based on a common type of object depicted in the image;
each of the digital images in the grouping comprising a rating;
display the images in a ranked order on a machine display based on the rating;
receive user input adjusting the rating or ranked order; and
storing results of the user input in association with the digital images and common object type, for upload to a server system via the wireless data network.

2. The system of claim 1, further comprising a second non-transitory machine memory comprising second instructions that, when executed by a second machine processor, operate a second device comprising the first processor to:
generate an uncompressed neural network;
train the uncompressed neural network based on a training set;
receive the results of the user input from the first device, and similarly generated stored results from a plurality of other devices, via the wireless data network;
retrain the uncompressed neural network with the results of the user input;
compress the uncompressed neural network into a compressed neural network by applying quantization based on execution capabilities of the first device; and
transmit the compressed neural network to the first device and to a set of other devices that are a same type as the first device.

3. A method comprising:
receiving one or more images;
associating one or more labels with each of the one or more images;
building a neural network from the one or more images and the one or more labels;
compressing the neural network into a compressed neural network;
embedding the compressed neural network into a software development kit on a client device;
receiving an input from the client device at the software development kit;
operating the software development kit to interface the compressed neural network to generate a result from the input; and
sending the result to the client device to be displayed on a machine display of the client device.

4. The method of claim 3, wherein compressing the neural network further comprises pruning the neural network by removing computations from the neural network.

5. The method of claim 3, wherein compressing the neural network further comprises altering a bit accuracy via quantization of the neural network.

6. The method of claim 3, further comprising:
generating an updated neural network from the neural network; and
sending the updated neural network to the software development kit on the client device.

7. The method of claim 6, further comprising:
sending the result to a neural network updating system, the neural network updating system generating the updated neural network in response.

8. The method of claim 6, further comprising:
receiving an update threshold; and
sending the updated neural network to the software development kit in response to the updated neural network exceeding the update threshold.

9. The method of claim 6, further comprising compressing the updated neural network.

10. A system comprising:
an image labeler to:
receive one or more images; and
associate one or more labels with each of the one or more images;
a neural network generator to build a neural network from the one or more images and the one or more labels;
a neural network compressor to compress the neural network into a compressed neural network; and
a software development kit on a client device to:
receive and embed the compressed neural network;
receive an input from the client device;
interface with the compressed neural network to generate a result from the input; and
send the result to the client device to be displayed on a machine display of the client device.

11. The system of claim 10, wherein the neural network compressor prunes the neural network by removing computations from the neural network.

12. The system of claim 10, wherein the neural network compressor alters a bit accuracy of the neural network.

13. The system of claim 10, wherein the neural network generator further comprises a neural network updating system to:
generate an updated neural network to the neural network; and
send the updated neural network to the software development kit on the client device.

14. The system of claim 13, wherein the neural network updating system receives the result and generates the updated neural network in response.

15. The system of claim 13, wherein the neural network updating system:
receives an update threshold; and
sends the updated neural network to the software development kit in response to the updated neural network exceeding the update threshold.

16. The system of claim 13, wherein the neural network updating system utilizes the neural network compressor to compress the updated neural network.
